(19) United States
(12) Patent Application Publication
(10) Pub. No.: US 2012/0169111 A1
(43) Pub. Date: Jul. 5, 2012

(54) DRIVING AID FOR A MOTOR VEHICLE

(76) Inventor: Kioumars Navidi, Darmstadt (DE)

(21) Appl. No.: 13/201,696

(22) PCT Filed: Feb. 18, 2010
(86) PCT No.: PCT/EP2010/001011

§ 371 Date: Mar. 14, 2012

(30) Foreign Application Priority Data
Feb. 18, 2009 (DE) 102009009411.3

(51) Int. Cl. B60B 15/26; B60B 15/00

(52) U.S. Cl. 301/46; 301/41.1

(57) ABSTRACT

A driving aid is provided for a motor vehicle on a slippery roadway and includes an auxiliary wheel with frictional elements adapted to be shifted between an inoperative position at a distance from the roadway and an operative position with frictional contact with the roadway and having an operative connection to an associated tire of the motor vehicle.

The invention relates to a driving aid for a motor vehicle on a slippery roadway.

In motor vehicles a motive force generated by the motor vehicle is customarily translated into locomotion of the motor vehicle via a rotating movement of the tires that are actuated by the motor vehicle. The direction of the locomotion is determined by the changeable direction of the tires that customarily are steerable in pairs and that are mounted around a vertical axis in a swiveling manner.

If the tires do not have any traction on a slippery roadway and slide across the roadway, neither speed nor direction of travel of the motor vehicle can be controlled reliably. The driving properties of the motor vehicle deteriorate on slippery roadways or on poor pavement conditions. In particular when the braking distance is considerably longer due to snow or ice, which is not adequately considered or estimated correctly by the driver, there is an increase in the number of accidents on slippery or slick roadways. This results in considerable damage and often times to injuries to the parties involved.

In order to improve the driving properties of the motor vehicle on a slippery roadway and in particular on a snow covered roadway, it is known to place snow chains onto tires. Snow chains customarily have chain sections arranged at a distance from one another on the tread of a tire that are lateral relative to the direction of travel and tread, said chain sections preventing the tires from spinning on slippery roadways. Since the snow chains have a negative impact on the driving properties of the motor vehicle when the roadway is dry and provides sufficient traction, snow chains usually are only mounted on tires when needed and are removed again as soon as they are no longer necessarily required. The snow chains must be brought along so they can be mounted again when needed. The necessity to keep the snow chains in the motor vehicle at all times and the work that is required to mount the snow chains often is considered to be a disadvantage.

From practical applications it also is known to arrange projecting forms or tips in the tread of a tire or for the tire to have numerous projecting spikes that are arranged at a distance from one another and are embedded in the tread. Tires equipped with such projecting forms or spikes, respectively, display substantially better traction properties when roadways are slippery or covered with snow and are able to reduce the risk of spinning of actuated tires or the risk of tires that define the direction to slip laterally to any given direction. However, such tires equipped with so-called spikes are very noisy on the roadways and can damage the roadway surface.

For traffic safety reasons the maximum speed of a motor vehicle is reduced when tires with spikes are used. The spikes customarily are arranged in a fixed manner in the tire and it is not possible to mount or activate them on short notice. If necessary, the tires that are usually used must be exchanged with tires with spikes. This requires changing the tires, which usually is very labor intensive. In addition, the spike tires must be available or must be stored in case they are needed.

The use of snow chains as well as the use of spike tires results in reduced comfort and sometimes only provides a small improvement of the driving properties while the required effort often seems unacceptably high. Electronic steering systems such as ABS or ESP that allow the individual tires to be actuated individually, for example in order to achieve a high effective brake effect or to be able to guarantee driving properties that the driver can control, often are not enough to avoid accidents reliably when roadways are covered with snow or ice.

The object of the present invention therefore is to provide a driving aid for a motor vehicle on slippery roadways so that the driving properties of the vehicle can be improved if necessary without requiring any extensive mounting and without negatively affecting the driving properties of the motor vehicle when the roadways are dry and provide traction.

The object is attained in accordance with the invention in that an auxiliary wheel which is provided with frictional elements can be shifted between an inoperative position at a distance from the roadway and an operative position with frictional contact with the roadway and with an operative connection to an associated tire of the motor vehicle.

In its operative position the auxiliary wheel which is provided with frictional elements is put into motion by its associated tire with which it has an operative connection. In doing so the auxiliary wheel as a rule is put into a rotating movement in the same direction as the associated tire. Preferably, the auxiliary wheel is moved at an approximately identical roll speed as the associated tire due to the operative connection.

Due to the frictional elements the auxiliary wheel having frictional contact with the roadway in its operative position has a substantially greater frictional resistance than the associated tire and thus decidedly supports the movement that is determined by the associated tire. When suitable frictional elements are used and provided the contact pressure of the auxiliary wheel on the roadway is high enough, spinning or slipping of the auxiliary wheel on icy or snow covered roadways can be avoided in most cases. The motive force exerted by the associated tire then is transmitted onto the auxiliary wheel via the operative connection and translated into the desired movement of the vehicle.

If the assistance of the auxiliary wheel is not considered necessary, the auxiliary wheel can be shifted from its operative position to an inoperative position. In the inoperative position the auxiliary wheel is not in contact with the roadway. Preferably there also is no operative connection to the associated tire anymore so that the auxiliary wheel is no longer moved while it is in an inoperative position and in particular is not put into a rotating movement. In its inoperative position the auxiliary wheel does not affect the driving properties of the motor vehicle. In addition, there is no damage to the roadway surface due to the fact that the auxiliary wheel is arranged at a distance. When the auxiliary wheel is in an inoperative position, the motor vehicle is not subject to any actual or legal limitations that apply to other aids. In particular, no time-limited driving bans or speed limits must be observed when the auxiliary wheel is in an inoperative position.

Preferably the auxiliary wheel has spikes extending from its tread. The spikes can be in the form of projecting metal studs and can be permanently embedded in a suitable tire material. Contrary to already known tires with spikes the auxiliary wheel can have a large number of spikes arranged in close proximity to one another since the weight of the vehicle rests mostly on the tires of the vehicle with an unchanged contact area and the auxiliary wheel can only be added and used for actuating, respectively for moving the vehicle.

Preferably a contact pressure of the auxiliary wheel onto the roadway surface can be set independent of the vehicle weight. Since the tread of the auxiliary wheel does not necessarily need to roll over the roadway, it is possible to use a large number of spikes so that only the ends of the spikes of the auxiliary wheel make contact with the roadway surface.

Preferably the auxiliary wheel is arranged laterally next to the associated tire. Such an arrangement makes it possible to shift the auxiliary wheel from an operative position into an inoperative position in a space-saving manner. For this purpose there may be a corresponding recess in a wheel housing of the vehicle. When the auxiliary wheel is arranged on a side facing the inside of the vehicle, it also is possible to prevent the auxiliary wheel and the spikes attached to it from being easily accessible from the outside.

In an advantageous embodiment of the inventive thought the auxiliary wheel has an operative connection to a driving roller which can be pressed against the tread of the associated tire when said driving aid is in the operative position. Thus a separate drive of the auxiliary wheel is not required. The rotating movement of the auxiliary wheel follows the rotating movement set by the associated tire. The operative connection between the auxiliary wheel and the driving roller advantageously is such that the auxiliary wheel moves at the same roll speed or circumferential speed, respectively, as the associated tire. The driving roller expediently is mounted in a freely rotable manner in both directions and transmits the rotating movement of the associated tire independent of its rotary direction onto the auxiliary wheel so that the auxiliary wheel can support a forward as well as a backward movement of the motor vehicle.

To avoid any sudden, jerky rotary acceleration of the auxiliary wheel during a first contact of the auxiliary wheel or driving roller, respectively, with the associated tire which also might be rotating fast, the auxiliary wheel may be put into a rotating movement that is adapted to the rotating movement of the tire before or while it is brought close to the associated tire or, respectively, while it is shifted to the operative position. For example, air blades arranged on the auxiliary wheel could generate a rotating movement of the auxiliary wheel that is determined by the airstream. The rotating movement that is adapted to the tire can also be determined by means of suitable sensors or can be set based on a comparison with the speed indicated on the speed indicator or, respectively, speedometer and can be generated by a suitable rotary drive of the auxiliary wheel or the driving roller.

According to an embodiment of the inventive thought the driving roller can be laterally deflected against a reset force and the lateral deflection is captured by sensors and is limited by end stops. In this manner the steering movements of the tire can be determined that result in a lateral deflection of the driving roller that is in contact with the tire. To prevent the tire as well as the auxiliary wheel from touching the roadway during a steering movement,

or from being pushed onto the roadway with great force and, at least in the case of the auxiliary wheel, from having to be pushed laterally across the roadway, the auxiliary wheel can be lifted or lowered further when a steering movement is detected via the lateral deflection of the driving roller so that during a steering movement only either the tire or the auxiliary wheel must be in contact with the roadway and must follow the steering movement.

Expediently, during operation, the driving roller is in operative connection with a cleaning device. Dirt or snow carried along by the associated tire during rolling can be kept away or removed continuously from the driving roller by a suitable cleaning device so that sufficient contact or friction contact, respectively, between the driving roller and the associated tire can be guaranteed continuously. The cleaning device can be comprised, for example, of a wiper strip or a brush device that cleans the tread of the associated tire or the driving roller.

In order to achieve a simple and reliably actuable displacement of the auxiliary wheel, the auxiliary wheel can be shifted between the inoperative position and the operative position by means of a hydraulic or pneumatic actuating device. The hydraulic or pneumatic actuating device may be coupled to a hydraulic or pneumatic pressure system already existing in the vehicle, if necessary. If a motor vehicle is retrofitted with the driving aid according to the invention, it is possible to subsequently and inexpensively install separate hydraulic or pneumatic actuating devices in the vehicle. The hydraulic or pneumatic actuating device can be operated either manually or in an automated manner.

The auxiliary wheel with an operative connection to a driving roller can be mounted in a swiveling manner around a swiveling axis to the actuating device or can be mounted on it. When the auxiliary wheel is shifted to an inoperative position it is possible to simultaneously carry out a swiveling movement so that a space-saving arrangement of the auxiliary wheel near the tire is possible. In particular, the driving roller that expediently extends, at least approximately, across the width of the tire, can be brought into an inoperative position near the tire by swiveling the auxiliary wheel together with the driving roller so that undesired contact with the tire is impossible in said position and at the same time only a small additional space for the driving roller in the area of the fender or the vehicle body is required.

There must be sufficient space for the auxiliary wheel as well as the driving roller in the operative position as well as in the inoperative position since the auxiliary wheel and the driving roller as well as the tire can be fixed to the suspension of the tire and deflect together with the tire when a load is applied or when running along the roadway. Regardless of what position the tire is in, the auxiliary wheel and the driving roller must not be in contact with the vehicle or with the body, respectively, for example with the adjacent fender. If there is not enough space in the vicinity of a steerable tire, the driving aid may be limited to non-steerable tires. It also is possible and advantageous for many requirements to have an inoperative position in the area of the steerable tires only for one alignment of the steerable tire, for example without steering deflection, so that the auxiliary wheel can only be activated or shifted to the inoperative position in this set alignment. It also is possible to have an inoperative position in the swiveling range of the auxiliary wheel between directional stability and an inward steering deflection only, while an inoperative position with outside steering deflection is not possible since a collision with the outside shell of the fender could not be avoided.

Retrofitting the driving aid as a rule is possible and often does not require any or only minimal modifications to the vehicle, provided the retaining device and the auxiliary wheel are designed in a suitable manner. In addition, the driving aid can be designed such and can be attached to the vehicle in a manner that ensures that easy mounting and removal is possible. When the driving aid is fastened, one expediently should ensure that the driving aid can be attached in a relatively rigid manner to the vehicle in relation to a tire that is mounted in a moveable manner via a shock absorber and a spring device. Required connecting lines for hydraulic or pneumatic pressure connections or electric energy and control lines, for example, can be achieved in a simple manner using standard plug connections.

In order to be better able to absorb the forces that occur during operation and to transmit them to the vehicle, the auxiliary wheel, while in operative position, can be connected to a counter bearing via a cable control so that the forces that act on the auxiliary wheel can also be absorbed via the counter bearing. The counter bearing expediently is arranged on a side opposite the auxiliary wheel, customarily in a front area of the tire. Using suitable guide elements, the cable control is guided in an arch-shape approximately along the tire circumference from a first end in the area of the auxiliary wheel to the counter bearing arranged on the opposite side. When the auxiliary wheel is pushed onto the roadway during operation and the weight of the vehicle must be absorbed via the actuating device, a part of the forces to be absorbed can be transmitted to the counter bearing via the cable control in order to relieve the actuating device.

In order to ensure that the motive force generated by the motor vehicle is converted to a vehicle movement as evenly as possible and to avoid an uneven acceleration of the motor vehicle which could impact directional stability, the driving aid has two auxiliary wheels that are arranged on two opposite tires. If auxiliary wheels are arranged on only two and not on all opposite tires, the auxiliary wheels expediently are arranged on the rear tires.

It also is possible to have associated auxiliary wheels on all tires. During a braking process the auxiliary wheels arranged in the rear should be activated first. The auxiliary wheels expediently can be actuated and activated or deactivated, respectively, either individually or separately in pairs. Auxiliary wheels on the front, steerable tires in particular can support the direction set by the steerable tires while auxiliary wheels on the rear tires advantageously support acceleration and, in particular, braking processes. The activation of individual auxiliary wheels can also be accomplished via the brake system or can be coupled with the brake system, respectively, and can act together with it.

Furthermore, it is expedient for the auxiliary wheels that are arranged on two opposite tires to be jointly actuated by means of a joint hydraulic or pneumatic actuating device. This ensures not only that the auxiliary wheels simultaneously support a rotating movement of the tires on both sides of the motor vehicle or simultaneously are in the inoperative position, respectively, but also that the auxiliary wheels or the respective associated driving roller have an operative connection with the associated tire with the same contact pressure. This provides a simple means for ensuring that the driving aid acts evenly on both sides of the motor vehicle or evenly supports the respective rotating movement of the tires, respectively. By designing the driving aid accordingly, all-wheel drive vehicle driving properties are achieved when the driving aid is actuated, regardless of which axles of the motor vehicle are actuated.

The contact pressure of the one auxiliary wheel or of the plurality of auxiliary wheels can be adjusted in several stages or continuously and can be set either manually or in an automated manner. An automated adjustment of the contact pressure of the auxiliary wheels in relation to the roadway surface can be set based on the surface properties of the roadway, the speed of the vehicle or icy conditions that are determined or estimated using suitable means.

The contact pressure can also be reduced manually or in an automated manner, in particular in order to not noticeably impede the steering movement of the steerable tires at low speed, which would impact the operating comfort.

According to an especially advantageous embodiment of the inventive thought the driving aid has guide elements engaging laterally around the associated tire for each auxiliary wheel in order to guide the auxiliary wheel relative to the associated tire. For this purpose the at least one guide element has at least one guide ball mounted in a freely rotatable manner that is mounted laterally facing the sidewalls of the tires. In this manner the auxiliary wheels can follow the swiveling movements of a tire mounted in a swiveling manner around a vertical axis for the purpose of determining the direction. The auxiliary wheels can also follow a slight tilting of a tire around a horizontal axis as it is intended for high speeds, in particular for rear wheels of high end cars, in order to improve their driving properties.

In an advantageous manner a separating device is arranged between the auxiliary wheel and the associated tire, said separating device preventing any direct contact between the tire and the auxiliary wheel arranged laterally next to it in the operative position. The separating device expediently can simultaneously be used as a guide element.

In order to ensure that the auxiliary wheel, regardless of the respective alignment of steerable front tires, is mounted and activated at any time in a spatially adjustable inoperative position or can be shifted to an operative position, respectively, in which the auxiliary wheel is in contact with the tire that is aligned in any direction, the at least one guide element advantageously can be shifted between an inoperative position at a distance from the tire and an operative position resting laterally on a sidewall. In the inoperative position of the auxiliary wheel the guide element can be removed from the tire so that the guide element does not force any alignment of the auxiliary wheel and the auxiliary wheel can be shifted into a respective inoperative position using suitably arranged tension or pressure springs or cable controls, regardless of the alignment of the associated tire. When the auxiliary wheel is to be activated, first the guide element is brought into contact again with the tire on a sidewall of the tire via the tension or pressure springs or cable controls, for example, and thus, due to its position set by the tire, sets a corresponding swiveling movement of the auxiliary wheel during the approximation to the associated tire. Such a setting of the direction of the auxiliary wheel in most cases is required or necessary, respectively, only for an arrangement of the auxiliary wheel for steerable tires that swivel around a vertical axis.

The guide element can be forced to move via two cable controls, for example, with operative connection to the guide element as well as the retaining device for the auxiliary wheel. When the auxiliary wheel is shifted to the inoperative position or to the operative position, respectively, the guide element is moved away from the sidewall of the tire or is moved to the sidewall respectively, via the respective associated control wire. Using a suitable arrangement and fixing of the control wires it also can be ensured that the non-activated auxiliary wheel maintains a settable alignment regardless of an alignment or a swiveling movement of the associated tire or, respectively, is retained in a settable inoperative position.

The guide element can also be shifted via an electric motor, said motor having an operative connection to the guide element via a gear drive. The electric motor simultaneously can be used for aligning the auxiliary wheel in a suitable manner and for keeping it in the intended position, if necessary, when the auxiliary wheel is shifted to its inoperative position.

The guide can also be actuated and shifted by magnetic, hydraulic or pneumatic actuating elements or controlling elements, for example.

When the auxiliary wheel is shifted from the inoperative position to the operative position and back, it must expediently be ensured that first there is an alignment of the auxiliary wheel via the guide element or via the plurality of guide elements, respectively, before there is an approximation to the preset end position in order to ensure that the auxiliary wheel can be actuated without any problems regardless of the respective alignment of the associated tire. At the same time, it must also be ensured that the auxiliary wheel, with a preset alignment of the tire, neither comes in contact with a fender nor another part of the body of the motor vehicle nor with the swiveled tire during activation of the operative position or during the shifting from the inoperative position to the operative position, respectively, before the auxiliary wheel can be guided or aligned relative to the associated tire.

If a plurality of guide elements are used in the area of a vertical swiveling axis of the tire as well as laterally in a rear area of the tire, first an approximate alignment of the auxiliary wheel should be set via the guide element arranged in the upper area of the swiveling axis and then the alignment of the auxiliary wheel should additionally be set via a lateral approximation and lateral engagement of additional guide elements in the rear area of the tire before the auxiliary wheel is pressed against the roadway surface. If this is not done, laterally applied or acting forces caused by the different alignment of the auxiliary wheel relative to the tire could swivel the auxiliary wheel relative to the tire so that the driving aid could be impaired or damaged.

The selected direction can be determined using a mechanically or electronically actuated guide device and can be transmitted to or forced onto the auxiliary wheel. If an electronic guide is used instead of the above described mechanical guide using suitable guide elements, it is possible to use optical or magnetic sensors and electrically drivable control elements, for example, for aligning the auxiliary wheel.

The guide elements can be equipped with additional sensors that capture excessive contact pressure of the tire and report it to a central control unit. If the guide elements capture a steering movement of the associated tire, the auxiliary wheel can be lowered more or lifted somewhat during operation to prevent the tire as well as the auxiliary wheel from making contact with the roadway surface at a distance from one another or from being pressed onto the roadway surface causing them to be shifted laterally across the roadway surface with a preset steering movement.

To prevent the auxiliary wheel in the inoperative position from oscillating or carrying out jerky movements due to unevenness of the ground or due to the airstream, which could have an undesirable impact on the driving comfort, the auxiliary wheel can be fixed in its inoperative position. Instead of fixing the auxiliary wheel it also is possible to fix the drive shaft in order to fix the auxiliary wheel in its position via the drive shaft.

The retaining device of the auxiliary wheel expediently is arranged in a stationary manner relative to the associated tire. The retaining device can be connected directly or indirectly with a chassis or a floor plan assembly of the vehicle. In this case the auxiliary wheel must be fixed to the chassis or floor plan assembly, respectively, as well.

It also is possible to fix or set, respectively, the retaining device relative to the tire and the inoperative position relative to a fender or a different part of the body in a stationary manner whereby the retaining device and the inoperative position can oscillate or shift relative to one other. In this case the retaining device should release the auxiliary wheel in the inoperative position around at least one suitably arranged swiveling axis so that a relative movement of the auxiliary wheel that is fixed in the inoperative position relative to the retaining device is possible.

In the following paragraphs some exemplary embodiments that are shown in the drawing are explained in more detail. The following is shown:

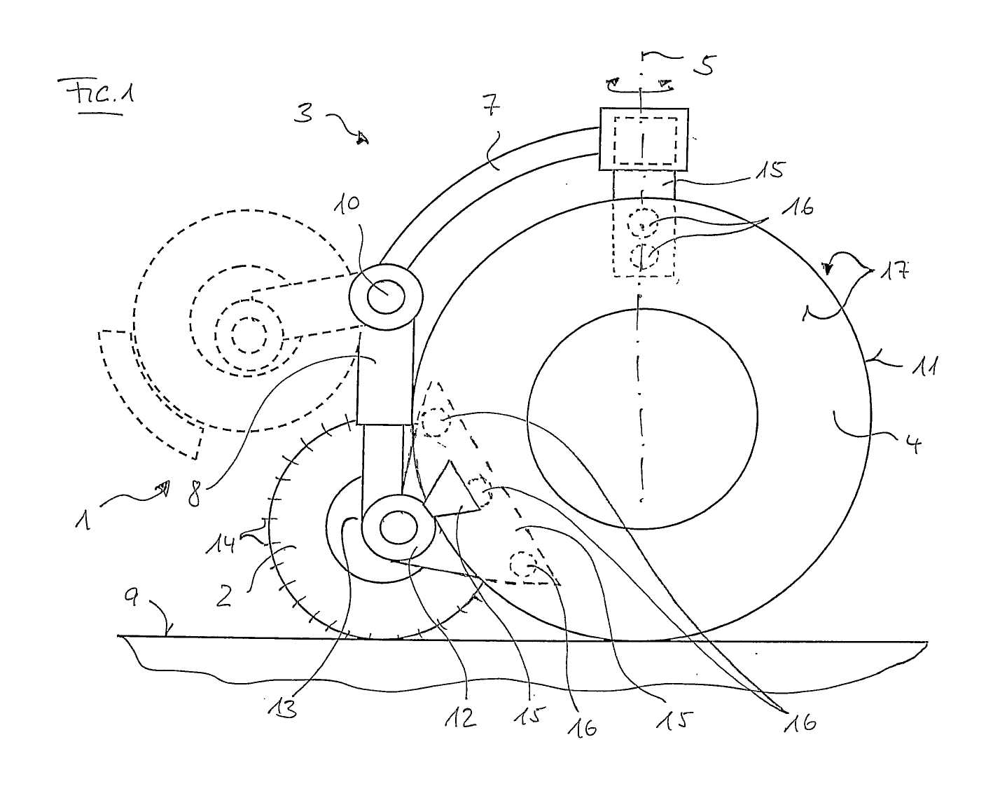

FIG. 1 shows a schematic lateral view of a driving aid having an auxiliary wheel that is arranged on a tire associated with the auxiliary wheel.

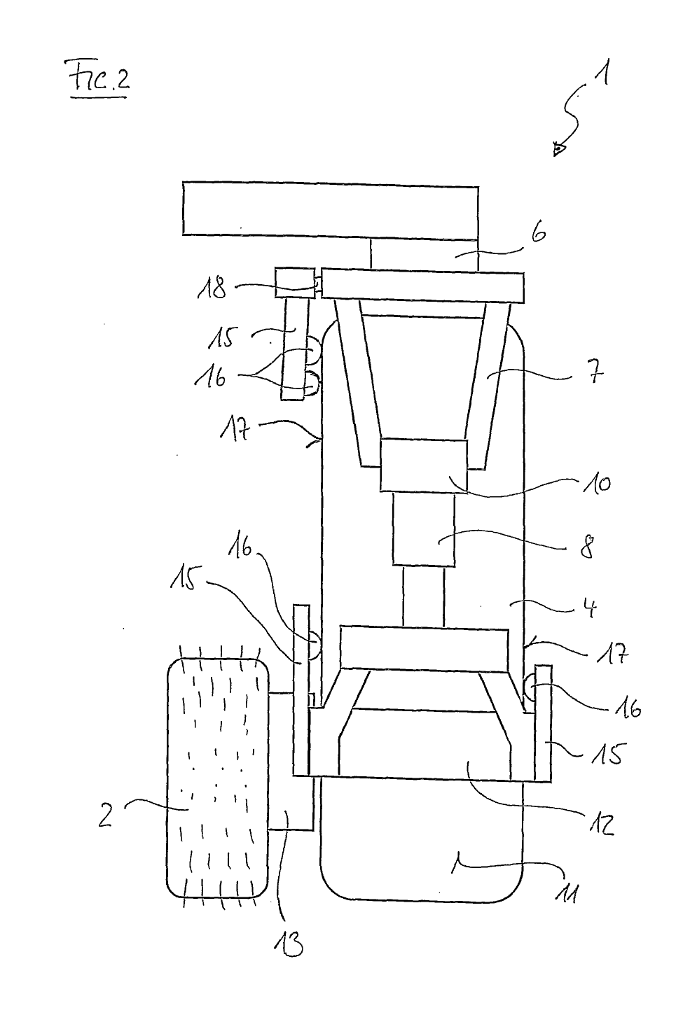

FIG. 2 shows the view from the back of the driving aid shown in FIG. 1.

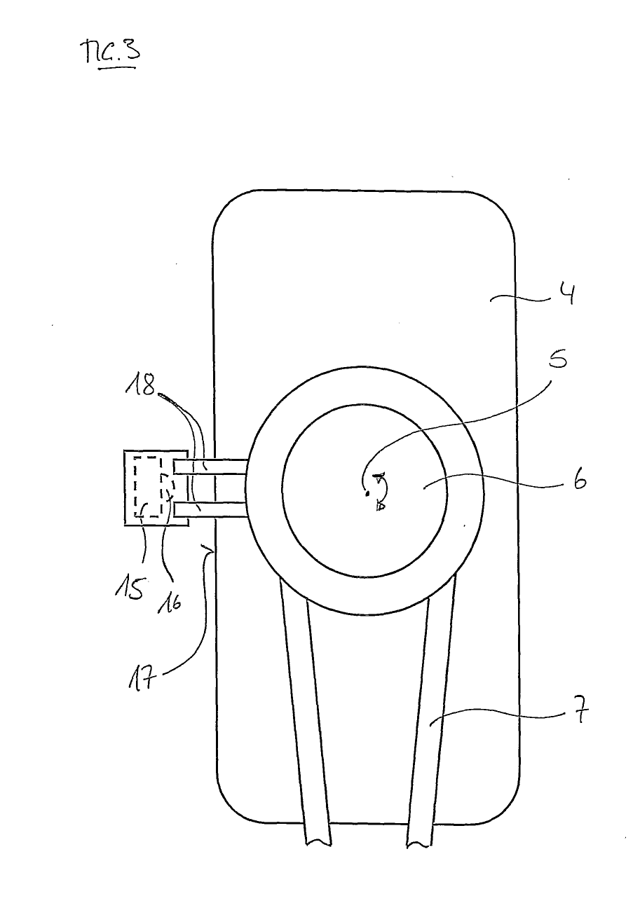

FIG. 3 shows an enlarged schematic top view of the driving aid shown in FIGS. 1 and 2 in the area of a lateral guide element.

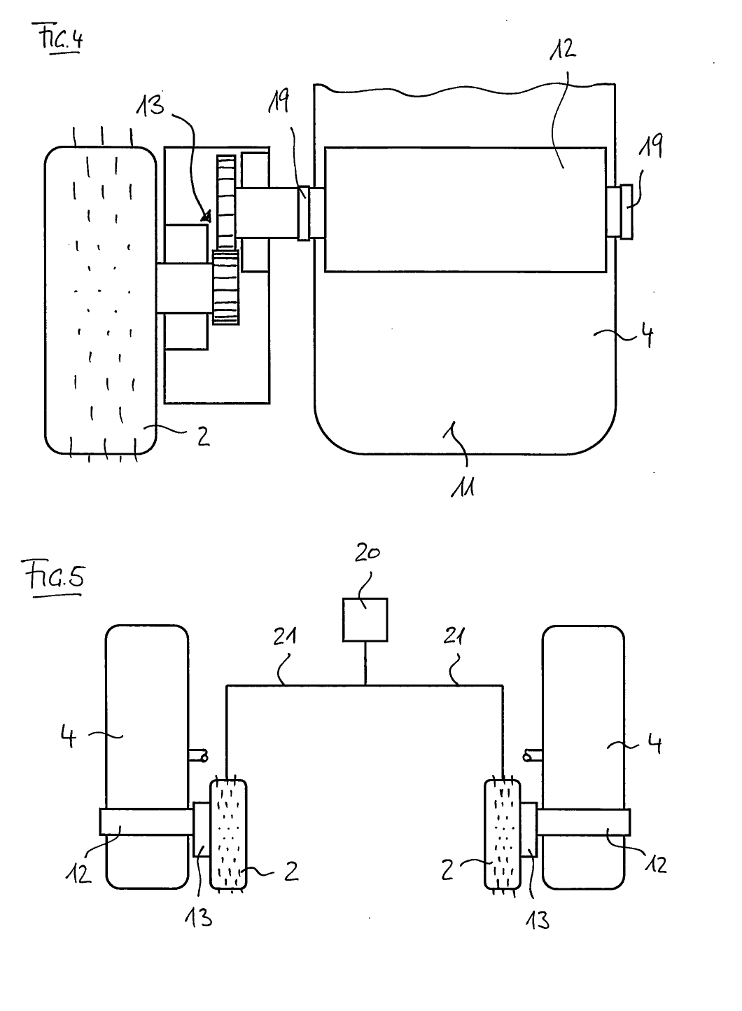

FIG. 4 shows an enlarged section view of the driving aid shown in FIGS. 1 through 3 in the area of the driving roller with an operative connection to the tire and the auxiliary wheel.

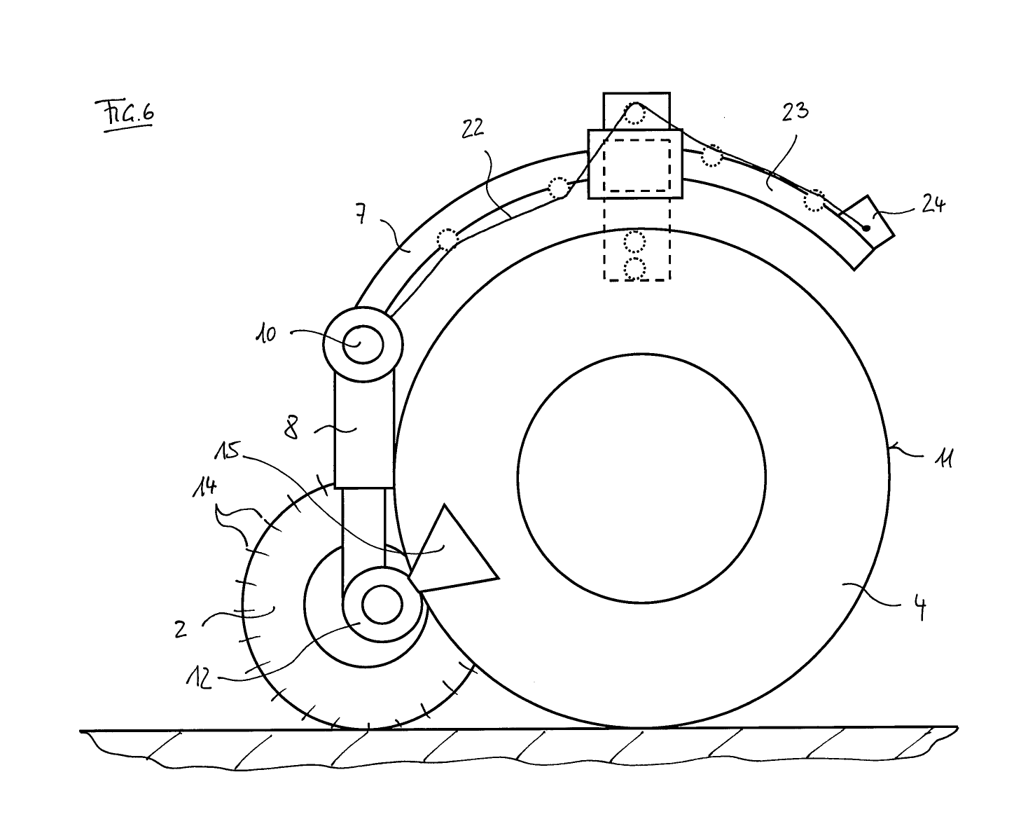

FIG. 5 shows a schematic view of a driving aid with two auxiliary wheels arranged on two opposite tires, said auxiliary wheels being jointly actuated by means of a joint hydraulic actuating device.

FIG. 6 shows a schematic lateral view of the driving aid shown in FIG. 1 with an additional cable control that transmits a part of the forces that occur during operation to a counter bearing.

A driving aid 1 for a motor vehicle on a slippery roadway shown in FIGS. 1 through 4 has an auxiliary wheel 2 that is fixed in the area of an associated tire 4 of the mart vehicle by means of a retaining device 3 and whose position can be shifted. The retaining device 3 can be fixed to a wheel bearing of the tire 4, for example, or, as shown in the exemplary embodiment in FIGS. 1 through 4, can be fixed in the area of a vertical swiveling axis 5, shown by a dash-dotted line, of the tire 4 above the tire 4 or laterally next to the tire 4 to a base column of the motor vehicle.

In order to be able to follow a swiveling movement of the tire 4 in the exemplary embodiment shown, the retaining device 3 has a swivel joint 6 in the area of the swivel axis 5. Starting from the swivel joint 6 the retaining device 3 comprises a retaining arm 7. The retaining arm 7 is sufficiently stable and mechanically resilient in order to press the auxiliary wheel 2 that is connected to the retaining arm 7 via a telescopic arm 8 onto the roadway surface 9 with sufficient contact pressure.

The telescopic arm is mounted in a swiveling manner to the retaining arm 7 so that the auxiliary wheel 2 can be swiveled from an operative position in which the auxiliary wheel 2 is in contact with the roadway surface 9 to an inoperative position, shown with a dashed line, by means of a swiveling device 10. At the same time the distance of the auxiliary wheel 2 in relation to the swiveling device 10 and thus to the roadway surface 9 as well as the contact pressure of the auxiliary wheel 2 on the roadway surface 9 can be set during operation by extending or retracting, respectively, the telescopic arm 8. Additionally the auxiliary wheel 2 can be mounted on the telescopic arm 8 in a swiveling manner in order to be arranged in a space-saving manner and at a sufficient distance from the tire 4 when in the inoperative position.

In order to avoid vibrations or undesired noise due to the auxiliary wheel 2 when it is in the inoperative position, a retaining arm or a receptacle can be arranged or fixed on the retaining device 3 and the auxiliary wheel 2 can be fixed to or in this receptacle in an interlocking manner, for example by means of hooks or snap elements, or by using frictional contact by pressing or clamping it in its inoperative position.

The swiveling device 10 and the telescopic arm 8 can be actuated independent from one another by means of a hydraulic actuating device.

A driving roller 12 that is associated with the tread 11 of the tire 4 is mounted in a rotable manner laterally next to the auxiliary wheel 2. The driving roller 12 has an operative connection to the auxiliary wheel 2 via a gear drive 13 so that a rotating movement of the driving roller 12 forces a corresponding rotating movement of the auxiliary wheel 2.

If necessary, the driving roller 12 can be pressed against the tread 11 of the associated tire 4 so that a rotating movement of the tire 4 is transmitted to the driving roller 12 and thus to the auxiliary wheel 2. Using a suitable translation of the gear drive 13 it is possible to achieve a roll speed of the auxiliary wheel 2 that is aligned with and corresponds to the roll speed of the associated tire 4.

For reasons of stability the gear drive 13 can be arranged inside a housing, said housing in turn being connected to the telescopic arm 8. The housing can partially enclose the auxiliary wheel 2 as well as the driving roller 12.

The auxiliary wheel 2 has a large number of spikes 14 that are embedded in the tire material of the auxiliary wheel 2. The spikes 14 are substantially comprised of metal studs with a suitable length and a suitable diameter. When in operative position the auxiliary wheel 2 is pressed onto the roadway surface 9 with a sufficient contact pressure. Simultaneously the driving roller 12 also is pressed onto the tread 11 of the tire 4 with sufficient contact pressure and transmits the rotating movement onto the auxiliary wheel 2. The spikes 14 on the auxiliary wheel 2 prevent the auxiliary wheel 2 from spinning or sliding laterally when the roadway surface is slippery due to snow or ice, for example, so that the joint rotating movement of the tire 4 and the auxiliary wheel 2 connected in an operative manner to it is translated into a desired movement of the motor vehicle.

The auxiliary wheel 2 can be arranged on the rear tire of a motor vehicle, said rear tire being substantially fixed in a stationary manner. According to the exemplary embodiment shown in FIGS. 1 through 4 the auxiliary wheel 2 can also be arranged on a tire 4 that can swivel around a vertical swivel axis 5, as is customarily the case for front tires of a motor vehicle. In order to be able to follow the swivel movements of a steerable front wheel, guide elements 15 that engage the tread 11 of the tire 4 for guiding the auxiliary wheel 2 relative to the associated tire 4 are arranged in the area of the swivel joint 6 above the tire 4 as well as in an area of the driving roller 12. The guide elements 15 have guide balls 16 that are mounted in a freely rotable manner with ball bearings, said guide balls 16 laterally engaging the tread 11 and being in close contact with the sidewall 17 of the tire 4, and follow the movements of the tire 4 and set the alignment of the retaining arm 7 or the auxiliary wheel 2 mounted to it, respectively, in relation to the tire 4 and guide it to follow the movements of the tire 4.

The guide element 15 that is arranged between the tire 4 and the auxiliary wheel 2 has a sufficiently large area to reliably prevent any direct contact between the tire 4 and the auxiliary wheel 2 with the spikes 14. On the other hand the guide element 15 arranged on the opposite side of the tire 4 is markedly smaller and engages the sidewall 17 of the tire 4 only marginally.

As is shown schematically in FIG. 3, the guide element 15 that is arranged on a front wheel in the area of its swivel axis 5 can be moved substantially vertically relative to a straight alignment of the tire 4 on tracks 18 so that the guide element 15 is laterally pushed onto the sidewall 17 of the tire 4 or can be removed from it. Instead of tracks 18 it also is possible to use rods or any other suitable shifting mechanism. Using a device for shifting the guide element 15, which is not shown in detail and which can be actuated with a spring, by means of a cable control or is activated and actuated electrically, the guide element 15 can be moved away from the sidewall 17 of the tire 4 during parking of the auxiliary wheel 2 in the inoperative position so that the guide element 15 no longer forces an alignment of the auxiliary wheel 2 and the auxiliary wheel 2 can be parked in a single position that can be set independent of the current alignment of the tire 4. When the auxiliary wheel 2 is activated, the guide element 15 can be pressed laterally against the tire 4 again and then would transmit the alignment of the tire 4 onto the auxiliary wheel 2 or would set the adjusted alignment of the auxiliary wheel 2, respectively.

The guide element 15 that is mounted above the tire 4 in the area of its swivel axis 5 can either—as shown—have two guide balls 16 or only one or a plurality of vertically arranged guide balls 16. Another possible adjacent arrangement of the guide balls 16 appears less favorable because this could impair the correct lateral contact or alignment of the guide element 15 and thus of the auxiliary wheel 2 relative to the tire 4.

FIG. 4 shows a schematic view of how the driving roller 12 can be shifted axially to a small degree against a reset force of a reset device that is not shown. This allows for a lateral deflection of the driving roller 12 which is limited by respective end stops 19 that simultaneously have sensors and report any contact with the driving roller 12 to a central control unit so that the auxiliary wheel 2 either is lowered or lifted a little in case of a swivel movement of the tire 4 due to a steering maneuver and the resulting lateral shifting of the driving roller 12. This prevents the auxiliary wheel 2 from being in contact with the roadway 9 during a steering movement of the tire 4 which would require the tire 4 as well as the auxiliary wheel 2 to be shifted across the roadway surface 9 against a friction force.

The sensors for determining a swivel movement of the tire 4 during a set steering maneuver can also be arranged in the guide elements 15 so that it is not necessary to arrange the driving roller 12 in a laterally shifting manner.

FIG. 5 shows a schematic view of a driving aid 1 with two auxiliary wheels 2. Each of the two auxiliary wheels 2 has an associated tire 4. The two tires 4 are opposite rear tires of a motor vehicle. Using a joint hydraulic actuating device 20, the two auxiliary wheels 2 can be shifted from an inoperative position to an operative position and the respective contact pressure of the driving roller 2 [sic] on the associated tire 4 can be set. If the pressure lines 21 that are associated with the respective auxiliary wheel 2 are coupled, the two auxiliary wheels 2 can easily be actuated simultaneously or can be shifted to the inoperative position and the respective contact pressure of the contact roller [sic] 12 is at least approximately as high as on the associated tire 4.

The two auxiliary wheels 2 can be shifted either manually or semi- or fully automatic by means of the hydraulic actuating device 20. The contact pressure of the driving roller 12 on the tread 11 of the tires 4 can be set in stages, for example, in order to provide for a pleasant or, respectively, sufficiently effective support from the auxiliary wheels 2 when the roadway surface has different properties. In particular for supporting [sic] an impairment of a steering movement of a tire 4 equipped with an auxiliary wheel 2 when the speed is low, the contact pressure of the driving roller 12 on the tire 4 varies depending on the speed, or, respectively, is reduced automatically during steering movements. Alternatively, the auxiliary wheels 2 also can be mounted in a swiveling manner around a vertical swivel axis, thus following the steering movements of the associated tires 4.

An arrangement of the auxiliary wheels 2 on non-steerable tires 4, i.e. usually rear tires of a motor vehicle, can be achieved easily from a design point of view and should be sufficient in practical applications to substantially improve the driving properties of the motor vehicle when the roads are slick.

In FIG. 6 the driving aid 1 shown in FIGS. 1 through 4 is equipped with an additional cable control 22.

One end of the cable control 22 is fixed to the telescopic arm 8 in the area of the driving roller 12. The cable control 22 is guided along the retaining arm 7 and along an apposite retaining arm 23 via a plurality of guide elements up to a counter bearing 24 and is fixed there as well. When an upward directed force acts on the retaining arm 7 during operation, a part of the upward directed force is transmitted to the counter bearing 24 by means of the cable control 22 so that the opposite retaining arm 23 absorb a part of the force as well. The length of the opposite retaining arm 23 can be adapted to the farces that customarily act on the retaining arm 7 so that the forces that are absorbed by the two retaining arms 7 or 23, respectively, are approximately equal. During this process the fact that the auxiliary wheel 2 is pushed downward to the roadway surface 9 as well as to the side to the tire 9 can be taken into account so that a resulting force on retaining arm 7 is generated and is absorbed together with retaining arm 23.

It also is possible to equip a motorcycle with such a driving aid 1. In this case it would be expedient to arrange an auxiliary wheel 2 behind an associated motorcycle tire.

The driving aid 1 according to the invention can also be used for airplanes or other vehicles whose locomotion is accomplished by means of tires.

1. Driving aid for a motor vehicle on a slippery roadway comprising an auxiliary wheel with frictional elements adapted to be shifted between an inoperative position at a distance from the roadway and an operative position with frictional contact with the roadway and having an operative connection to an associated tire of the motor vehicle.

2. Driving aid according to claim 1, wherein the tread of the auxiliary wheel has projecting spikes.

3. Driving aid according to claim 2, wherein the auxiliary wheel is arranged laterally next to the associated tire.

4. Driving aid according to claim 1, wherein the auxiliary wheel has an operative connection to a driving roller, which in operating position of the auxiliary wheel can be pressed against a tread of the associated tire.

5. Driving aid according to claim 4, wherein the driving roller can be deflected laterally against a reset force and in that the lateral deflection is captured by sensors and limited by end stops.

6. Driving aid according to claim 4, wherein the driving roller is in operative connection with a cleaning device during operation.

7. Driving aid according to claim 1, wherein the auxiliary wheel can be shifted between the inoperative position and the operative position by means of a hydraulic or pneumatic actuating device.

8. Driving aid according to claim 1, wherein the auxiliary wheel in operating position can be connected to a counter bearing by means of a cable control in order to absorb the forces acting on the auxiliary wheel via the counter bearing as well.

9. Driving aid according to claim 1, wherein the driving aid comprises two auxiliary wheels that are arranged on two opposite tires.

10. Driving aid according to claim 9, wherein the auxiliary wheels that are arranged on two opposite tires can be jointly actuated by means of a joint hydraulic or pneumatic actuating device.

11. Driving aid according to claim 1, wherein the driving aid has at least one guide element engaging laterally around the associated tire in order to guide the auxiliary wheel relative to the associated tire.

12. Driving aid according to claim 11, wherein the at least one guide element has at least one guide ball (16) mounted in a freely rotable manner that is mounted laterally facing a sidewall of the tire.

13. Driving aid according to claim 11, wherein the at least one guide element can be shifted between an inoperative position at a distance from the tire and an operative position while in lateral contact to a sidewall.

14. Driving aid according to claim 1, wherein a separating device is arranged between the auxiliary wheel and the associated tire that prevents any direct contact between the tire and the auxiliary wheel arranged laterally next to it in the operative position.

15. Driving aid according to claim 1, wherein the auxiliary wheel when in the inoperative position can be fixed relative to a chassis of the motor vehicle.

16. Driving aid according to claim 1, wherein the auxiliary wheel or the entire driving aid can be adapted or swiveled in relation to a preset speed-based tilting of the tire.
